(19) United States
(12) Patent Application Publication
(10) Pub. No.: US 2026/0329808 A1
(43) Pub. Date: Oct. 22, 2026

(54) STRUCTURE-SHY APPLICATION PROGRAMMING INTERFACE RESOURCE GRAPH RETRIEVAL

(71) Applicant: Oracle International Corporation, Redwood Shores, CA (US)

(72) Inventor: Scott Allan Deboy, Portland, OR (US)

(73) Assignee: Oracle International Corporation, Redwood Shores, CA (US)

(21) Appl. No.: 19/181,774

(22) Filed: Apr. 17, 2025

(51) Int. Cl. G06F 16/13

(52) U.S. Cl. CPC G06F 16/13

(57) ABSTRACT

The embodiments described herein are directed toward techniques and devices for information retrieval via a graph traversal. A method can include receiving a request from a user device for target information stored at a target computing resource. The method can further include accessing a first code block associated with a first computing resource. The method can further include determining a first attribute of the first computing resource. The method can further include determining a second computing resource. The method can further include traversing a graph to identify the target computing resource. The method can further include accessing the target information from the target computing resource. The method can further include transmitting the target information to the user device.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others.

In some instances, a computing system executing a CSP service is tasked with retrieving desired information that may require traversing one or more nodes of a computing infrastructure. The computing system can use a traversal techniques to search multiple nodes to find the desired information.

### BRIEF SUMMARY

A computing system can be tasked with accessing information from a target resource. In order to access the target resource, the computing system may use attribute information from another resource. The attribute information can include relationship information between resources. In particular, the attribute information obtained from one resource can be used to identify and access another resource. For example, in order to access a first resource (e.g., DNS zone), a computing system may use attribute information previously obtained from a second resource (e.g., DNS resolver). The computing system repeat this process until it identifies access the target resource using attribute information from another resource. Various embodiments are described herein, including computer-implemented methods, systems, non-transitory computer-readable media storing programs, code, or instructions executable by one or more processors, and the like. Some embodiments may be implemented by using a computer program product, comprising program/instructions which, when executed by a processor, cause the processor to perform any of the methods described in the disclosure.

The embodiments described herein are directed toward techniques and devices for information retrieval via a graph traversal. Example techniques and devices can include a computing system receiving, from a user device, a request for target information stored at a target computing resource.

The techniques and devices can further include the computing system accessing a first code block associated with a first computing resource based at least in part on the request.

The techniques and devices can further include the computing system determining a first attribute of the first computing resource based at least in part on the accessing the first code block.

The techniques and devices can further include the computing system determining a second computing resource based at least in part on the first attribute.

The techniques and devices can further include the computing system traversing a graph to identify the target computing resource based at least in part on a second attribute of the second computing resource.

The techniques and devices can further include the computing system accessing the target information from the target computing resource based at least in part on identifying the target computing resource.

The techniques and devices can further include the computing system transmitting the target information to the user device based at least in part on the request.

### BRIEF DESCRIPTION OF THE DRAWINGS

FIG. 1 is an illustration of an example computing system for information retrieval, according to one or more embodiments.

FIG. 2 is an illustration of an example data structure, according to one or more embodiments.

FIG. 3 is an illustration of an example input for traversing graph, according to one or more embodiments.

FIG. 4 is an illustration of an example information, according to one or more embodiments.

FIG. 5 is an illustration of an example information, according to one or more embodiments.

FIG. 6 is an illustration of an example information, according to one or more embodiments.

FIG. 7 is an illustration of example computing code for traversing a data structure, according to one or more embodiments.

FIG. 8 is an illustration of example target information, according to one or more embodiments.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A cloud service provider (CSP) deployment can include deploying an application using one or more CSP models (e.g., a Software-as-a-Service (SaaS) model, a Platform-as-a-Service (PaaS) model, an Infrastructure-as-a-Service (IaaS) model, or other appropriate model). The deployment can include architecting the application to be deployed, planning the deployment, implementing the deployment using the CSP model, and executing customer workloads using the deployed application.

In some instances, the CSP may impose conditions that need to be satisfied for a deployment. The CSP's conditions can include, for example, assigning regions in which the application can be deployed, a time window for deploying the application, adhering to the CSP's guidance on applications, provisioning a requisite number of load balancers or compute instances for the application, or other appropriate conditions. In order to determine whether the CSP's conditions have been met prior to deploying the application, the CSP may be configured to gather a significant amount of information from across multiple CSP computing systems. In many instances, the information for determining whether one application is compliant with the conditions can be different from the information for determining whether another application is compliant with the conditions. Therefore, for each application instance, a CSP developer may be manually writing code to access each of the resources across the different CSP computing systems to retrieve the desired information. In particular, a CSP developer may write specific code for each resource that may need to be accessed for the desired information. In many instances, a CSP developer writes code for list application programming interfaces (APIs) that rely on use of the correct resource-specific pagination code and error handling logic. Additionally, the CSP may desire to customize the resource's parameters in order to control what information is returned based on a request. The CSP can experience various issues as a result of manually writing the code to access the desired information. For example, software developers can be prone to making errors, such as typographical errors, logical errors, and syntax errors. Furthermore, the longer the code, the greater the probability that a developer will make an error writing the code. Additionally, as developers are writing the code, the CSP's resources (e.g., processors, storage, network bandwidth, or other CSP resources) may become dedicated to the software development. Therefore, the CSP resources that are being used for software development may not be used for some other purpose. Another issue can be that there are security risks associated with manually writing code. Developers may not practice proper security protocols and may leave the code exposed to a malicious actor.

Embodiments herein address the above referenced issues by providing techniques for an instruction configuration that can be used to for querying and accessing information without having to manually write code for accessing each resource used to obtain desired information. The instruction configuration can include a section that describes parameters to be used to access the information. The instruction configuration can further describe information to be used to determine additional resources for obtaining the desired information. The resources can be considered a chain of resources that are associated based on attributes of the resources. As described herein, a request for information can build on information that is obtained from a previous request, such that each request may dependent upon a previous request. For each request, an attribute can be identified to define the information to be used be obtain information from a subsequent request.

The embodiments herein provide technical advantages to the conventional techniques for accessing resources. The techniques described herein can operate using less code that conventional techniques of writing specific code for each resource that needs to be accessed for the desired information. As there is less code, there is less opportunity for a developer to make an error. Furthermore, a smaller amount of code can require less development time, and consequently fewer resources can be dedicated toward the development. Furthermore, one the code is developed, fewer resources can be used to store and otherwise manage the computing code. For example, a processor can use less space to store a shorter piece of code than a longer piece of code. Another technical advantage is that less the development time and the shorter the code, there are fewer opportunities for a security breach.

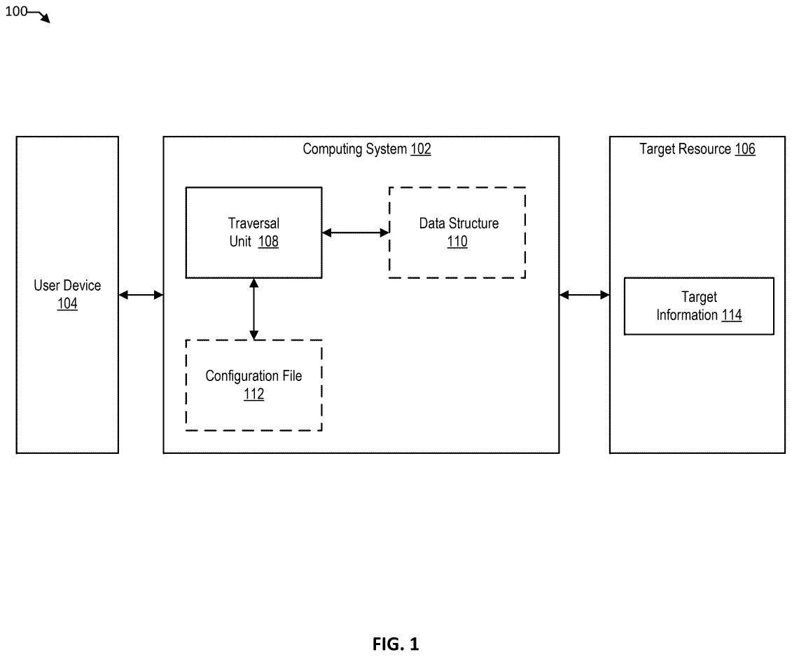

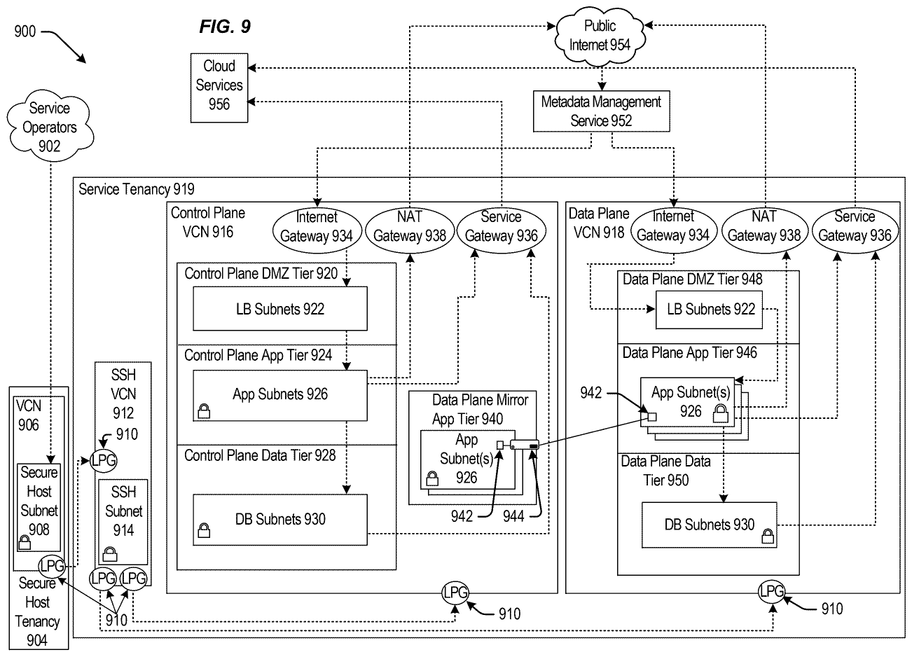

FIG. 1 is an illustration of an example computing system for information retrieval, according to one or more embodiments. A CSP can operate a computing system 102 for accessing information from various other computing resources (including other computing systems) of the CSP. The computing system 102 can be implemented as part of the one or more of the infrastructures described with respect to FIGS. 9, 10, 11, 12, and 13. The computing system 102 can be located at a single location, such as a data center. The computing system 102 may also be a distributed computing system that is located across different data centers at different locations. As indicated above, in some instances, a CSP may be configured to verify that an application scheduled to be deployed meets certain requirements. Whether the application meets the requirements can be determined by accessing information from various computing elements of the CSP's infrastructure. For example, a CSP condition can include a condition that a particular load balancer is used for managing requests to the application. Furthermore, a user device 104 can transmit a request for information regarding a condition (e.g., load balancer information). The information may only be obtained by traversing a chain of computing resources. Furthermore, accessing each resource my require information from a previous resource in the chain of resources. Furthermore, the load balancer information may be stored on a target resource 106. In some instances, the computing system 102 may need to traverse several nodes (e.g., resources) to access attribute information from each resource to reach the load balancer information.

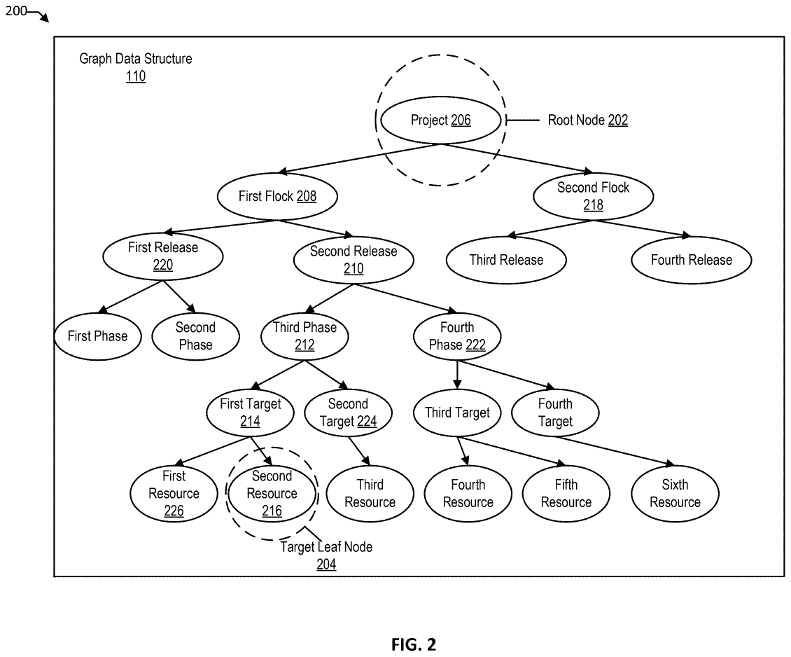

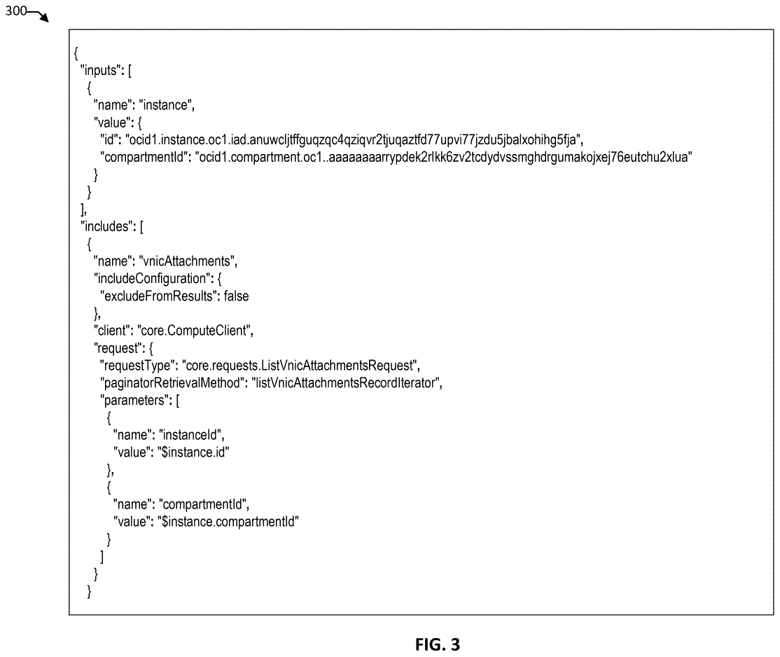

The computing system 102 can include a traversal unit 108 that is configured to use an instruction configuration to traverse resources represented by a data structure 110 in a systematic manner. An example of a data structure 110 is provided in FIG. 2. The following description is written with respect to a graph structure. However, it should be appreciated that the techniques herein can be used to access information from various resources based on attribute information that chains the resources together. One issue is that each node of the data structure 110 may have more than one leaf node, and therefore, the traversal unit 108 may need to use the attribute information determine which leaf nodes to select in order to obtain the desired information. Consider an example, in which the computing system 102 is tasked with accessing domain name server (DNS) records. A path from a compute instance to the desired DNS zone may include (1) a compute instance to (2) a virtual network interface card (VNIC) to (3) a DNS resolver association to (4) a DNS zone to a DNS zone record (5). The traversal unit 108 can make a series of application programming interface (API) calls to gather information to obtain the attribute information. In some embodiments, the attribute information can be stored in a configuration file that is stored in the memory of the computing system 102. In other embodiments, the configuration file can include a representation of attributes and their associated resources. The traversal unit 108 can make API calls to gather attribute information from nodes to determine subsequent leaf nodes (e.g., subsequent computing resource). For example, each time that the traversal unit 108 makes an API call to a node, the traversal unit 108 can access a value (e.g., attribute) that can be used to identify and access a subsequent leaf node (e.g., related resource). These values accessed via the API can define the relationships, such as dependencies, between the different nodes. The relationships are described with more detail with respect to FIGS. 3-7. The relationship information can be stored as metadata in the configuration file 112 and accessed to support a subsequent request for information from another computing resource.

It should be appreciated that as used herein, one example of a graph structure can be a directed graph that includes a set of nodes (e.g., vertices) connected by edges. The relationship between nodes can be a one-way relationship, rather than a bi-directional relationship. For example, if there is an edge from node A to node B, there may not be an edge from node B to node A. Furthermore, the graph structure may not have any cardinality constraints, such that there are no limits on the number of connections that a node may have.

Consider an example of a graph structure with node A, node B, and node C that represent input resources that contribute inputs to a process. The graph structure can further include node D and node E that represent intermediate resources for filtering and refining information before passing the refined information. The graph structure can further include node F and node G that represent endpoint resources that include target information.

Node A, node B, and node C can provide input parameters for a computing process. A computing system 102 can cause these inputs to flow through the graph. The inputs can be filtered at node D and Node E. The computing system 102 can cause the outputs of node D and Node E to flow through the graph to reach node F and node G, where target information can be reached.

It should be appreciated that graph structure can be larger than nodes A-E. For example, the graph structure can include nodes A-Z. Furthermore, the computing system may be interested in a subset of the nodes from the total nodes of the graph structure. For example, node D, node E, and node F can represent input resources. Additionally, node H, node I, and node J can represent intermediate resources. Furthermore, node R, node S, and node T can represent resources that include target information.

It should further be appreciated that reaching the nodes that include the target information may include traversing nodes that have not been expressly indicated as to be traversed. For example, to traverse from node H, node I, and node J to node R, node S, and node T may including traversing unspecified intermediate nodes (e.g., node K, node M, or other intermediate node). Additionally, the intermediate nodes that are used for filtering may also be determined to include target information. Using the example from above, if node H and node I are intermediate nodes used for filtering, these nodes may themselves represent resources that include target information to be retrieved in addition to target information from nodes R, S, and T. This implies that there is no limitation on the output nodes and intermediate nodes can contribute target information to a final result.

Consider another example of a graph that includes resource A and resource B. As described herein, once the data structure 110 has been traversed once, an attribute identifying a related resource can be identified. Therefore, the attribute information from resource A can be used to identify and access resource B. In general, the attribute information can enable the traversal unit 108 to identify and access a chain of resources to reach the target information. To expand the concept, the computing system 102 can use the attribute information from one resource to access a subsequent resource and so on.

The traversal unit 108 can use the attribute information to determine a path from a first resource to an nth resource (e.g., target resource 106) to access the target information 114. Once the traversal unit 108 determines the path, the traversal unit 108 can follow the path from the first resource to the nth resource to access the target information 114. Once the traversal unit 108 accesses the target information 114 from the resource 106, the computing system 102 can return the information to the user device 104.

FIG. 2 is an illustration 200 of an example data structure, according to one or more embodiments. It should be appreciated that the data structure illustrated in FIG. 2 is an example, and other the embodiments herein can be utilized with other data structures. In some instances, a path from a root node 202 to a target leaf node 204 can include various intermediate nodes. As illustrated, the path can flow from a project node to a flock node, to a release node, to a phase node, or a target node, and to a resource node. Although only the lowest layer of the data structure is named “resource,” each of the nodes can be associated with a computing resource. It is illustrated that a graph traversal unit (e.g., graph traversal unit 110) can follow a variety of paths from the project node to a resource node. However, the graph traversal unit can only follow one path from the root node 202 to the target leaf node 204. This path follows from the project node 206, to a first flock node 208, to a second release node 210, to a third phase node 212, to a first target node 214, and to the second resource node 216.

Each of these node can have a relationship defined in a configuration file (e.g., configuration file 112). The relationship can include information (e.g., values) that can be determined by accessing a first resource associated with a node. The information may then be required to be presented to a second resource associated with a dependent node to access the second resource. As indicated above, the configuration file may need to be initially built by accessing each of the nodes of the data structure. An example process for building the configuration file using the data structure 110 is provided below.

A computing system (e.g., computing system 102) can identify the root node 202 of the data structure. Each node of the data structure can be representative of a resource. The computing system can then resolve the root node 202 be identifying each dependent node, which in this case includes the first flock node 208 and the second flock node 218. The root node 202 can include relationship information that can be used to access the first flock node 208 and relationship information that can be used to access the second flock node 218. This relationship information can be stored in the configuration file.

For illustration consider the following entries of an instruction configuration.

```
“inputs”: [
  {
    “name”: “instance”,
    “value”: {
      “id”: “apid1.instance.ap1.xxxxxxxxxxxxxyyyyyyyyyyyyyy”,
      “compartmentId”: “apid1.compartment.ap1.mmmmmmmmmmnnnnnnnnnnn”
```

The above section can describe input parameters (e.g., attributes). The section can include names and value key pairs. The outer key-value pairs can include the pair “name” and “instance,” and the pair “value” and “the object describing instance id and the compartment id. The inner key-value pairs can include the pair “id” and “apid1.instance.ap1.xxxxxxxxxxxxxyyyyyyyyyyyyyy,” and the pair “compartmenid” and “apid1.compartment.ap1.mmmmmmmmmmnnnnnnnnnnn.” For example, using the example, above, the input parameters for an instance can include an instance id and a compartment id. This example may apply to a CSP that can organize instances (e.g., servers) based on compartments.

In this example, in order to access information on an instance, a computing system may need to provide “an instance id” and a compartment id. In order for the computing system to obtain the value “$ResourceA.attribute1” for “parameter3,” the computing system may need to resolve the project node 206.

These inputs can be accessed by subsequent blocks via an instruction. The instruction can include a symbol to indicate that to find a node and replace value. For example, if a block includes ${name}.{valueKey}, the computing system can recognize the symbol “$”. Based on the symbol, the computing system can access the node {name}, which appears before the period. The computing system can further replace {valuekey} with a value associated with the node {name}. for example, see the block below;

```
“parameters”: [
  {
    “name”: “instanceId”,
    “value”: “$instance.id”
  },
  {
    “name”: “compartmentId”,
    “value”: “$instance.compartmentId”
  }
```

The computing system can process the block and detect a symbol followed by a node and a key value. As illustrated, the symbol can be a “$” and the key can be “instance” and the value can be for the compartmentId key. Therefore, referring back to the “instance” node above, the computing system can access the value associated with the key “compartmentId,” which in this case is “apid1.compartment.ap1.mmmmmmmmmmnnnnnnnnnnn.”

For example, in the inputs sections, there are name and value keys, where a value key can contain a map with static keys and input-specific values. Consider the snippet from FIG. 3.

```
  {
  ″inputs″: [
    {
      ″name″: ″instance″,
      ″value″: {
        ″id″: ″xxxyyy″,
″compartmentID”: “xxxzzz″
      }
```

This snippet can include a JavaScript Object Notation (JSON) object and can be indicated by the curly braces. The snippet includes various key-values pairs. As illustrated, there are two keys “name” and “value.” The key “name” can include the string value “instance.” The key “value” can map to another JSON object indicated by the nested curly braces.

As illustrated, the nested JSON object can include two key-value pairs. The key “id” can have a string value, “xxxyyy.” The key “compartmentID” can have a string valu, “xxxzzz.”

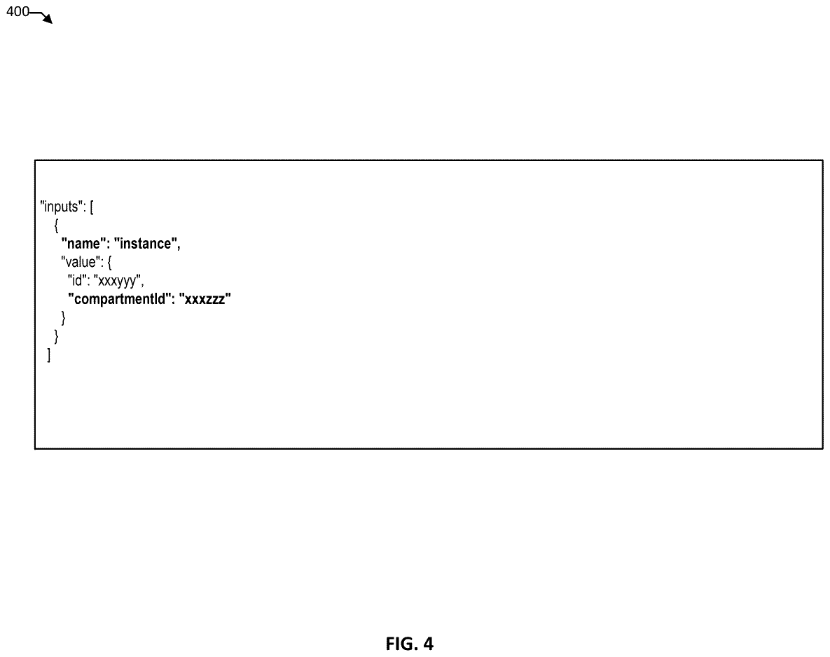

A computing system can access the above-referenced inputs in the subsequent blocks described in FIGS. 4-9. For example, the computing system can access the subsequent blocks using the expression ${name}.{valueKey}. The code can include indications to replace a parameter value with a node value. For example, if a dollar sign is the first character of a parameter value, this can indicate to replace this parameter value with the indicated node's value. In particular, this can indicate to find the node indicated before the dot, and set the field to the value map with that key. In some instances, the value is a list. In these instances, the computing system can execute the query for each value of the list.

Consider the snippet from FIG. 4:

```
{
  “includes”: [
    {
      “name”: “vnicAttachments”,
      “client”: “ComputeClient”,
      “request”: {
        “requestType”: “requests.ListVnicAttachmentsRequest”,
        “listVnicAttachmentsRecord”,
          “parameters”: [
            {
              “name”: “instanceId”,
              “value”: “$instance.Id”
            },
            {
              “name”: “compartmentId”,
              “value”: “$instance.compartment.Id”
            }
          ]
        }
},
```

For the ‘vnicAttachments block, the instanceID parameter can be set to $instance.id. As indicated above, if a parameter value starts with a dollar sign character, this can indicate to replace this parameter value with the indicated node's value. The key “value” has the value “$instance.Id,” which begins with a dollar sign. Therefore, the computing system can replace this value with the parameter value from the “instance” node and the key “id.” Referring back to the snippet of FIG. 3, the parameter value from the “instance” node and the key “id” can be“xxxyyy.”

The process described above can be applied for each node along each path from the project node 206 to each resource node. Furthermore, the information for accessing each subsequent node can be stored in the configuration file. As described above, this process can be computing resource intensive. For example, in a conventional system, a CSP developer may need to manually write code to access each of the nodes to access relationship information to be used to access a subsequent node. Furthermore, the CSP developer may need to manually write new code to access each of the nodes when searching for information related to a new parameter. For example, in one instance, a department of CSP may desire information relating to employment records stored at a leaf node. On another instance, the CSP may desire information relating to a list of servers. For each of these instances, the computing system may need to traverse several intermediate nodes before reaching the leaf node with the desired information. The computing system may provide initial input parameters (e.g., recordsEmployment, serversList) that guide the traversal to the desired information. Furthermore, in some instances, the different paths for two different pieces of information may even share one or more of the same intermediate nodes. However, for each of these instances, the CSP developer may need to manually write code for using an API to traverse the intermediate nodes and reach the desired leaf nodes. As described herein, the information for accessing each subsequent node along a path can be stored in a configuration file. The configuration file enables the CSP to traverse a path from the root node to each leaf node once and store the relationship information in the configuration file. In this sense, the CSP developers do not need to manually write code for accessing nodes each time that information from a leaf node is desired.

FIGS. 3-9 provide illustrations for a shy-structure traversal technique, in which metadata from a configuration file and can be to cause a computing system to return desired information from a target leaf node without returning information from any intermediate nodes. FIG. 3 is an illustration 300 of an input for traversing graph, according to one or more embodiments. FIG. 4 is an illustration 400 of an input for traversing graph, according to one or more embodiments. As indicated above, a graph traversal unit (e.g., graph traversal unit 108) can process an input for access information from a leaf node of a data structure (e.g., data structure 110). As opposed to conventional computing system, the input does not need to indicate each intermediate node to be traversed to reach the desired leaf node. Furthermore, the input does not include manually written code for reaching each of the nodes. Additionally, the input does need to provide values to be used to access each of the nodes. Based on the input, the graph traversal unit can access the configuration file (e.g., configuration file 112) that has an ordered set of “includes”, where each include can be a node that is to be traversed by the graph traversal unit. An example of an include is provided with respect to FIGS. 4-6.

Consider an example, in which, given a compute instance, a CSP desires all domain name server (DNS) records that are available to the compute instance. This query may require traversal of multiple resources including the instance, a virtual network interface card (VNIC) attachment, a subnet, a virtual cloud network DNS resolver association, a resolver, DNS zones, and a zone record. The embodiments herein can enable a computing system to traverse these resources without using resource-specific code. Rather, the embodiments herein can enable the computing system to use metadata stored in a configuration file to perform the traversal.

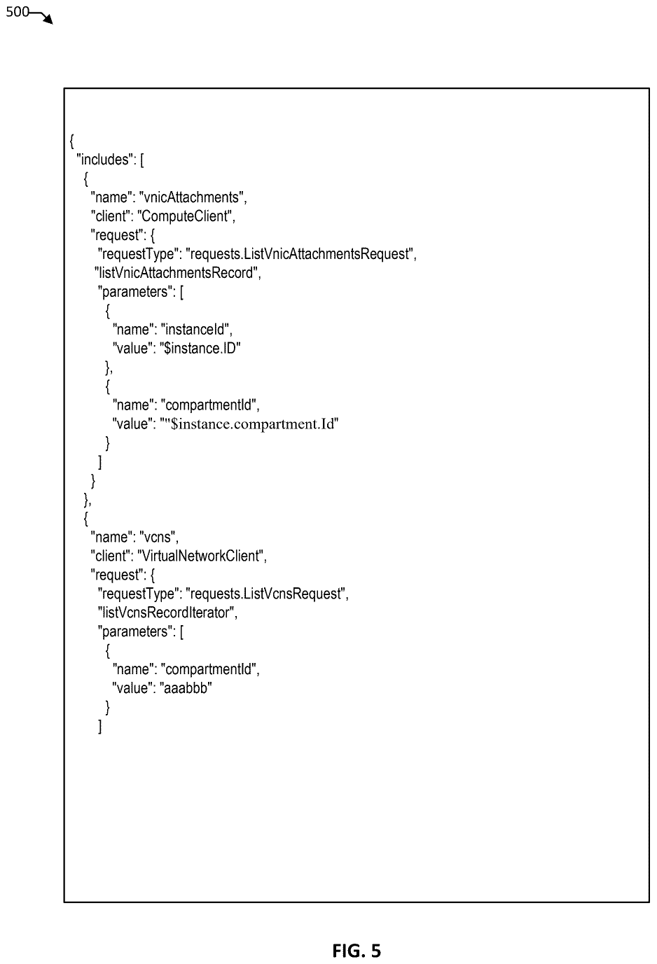

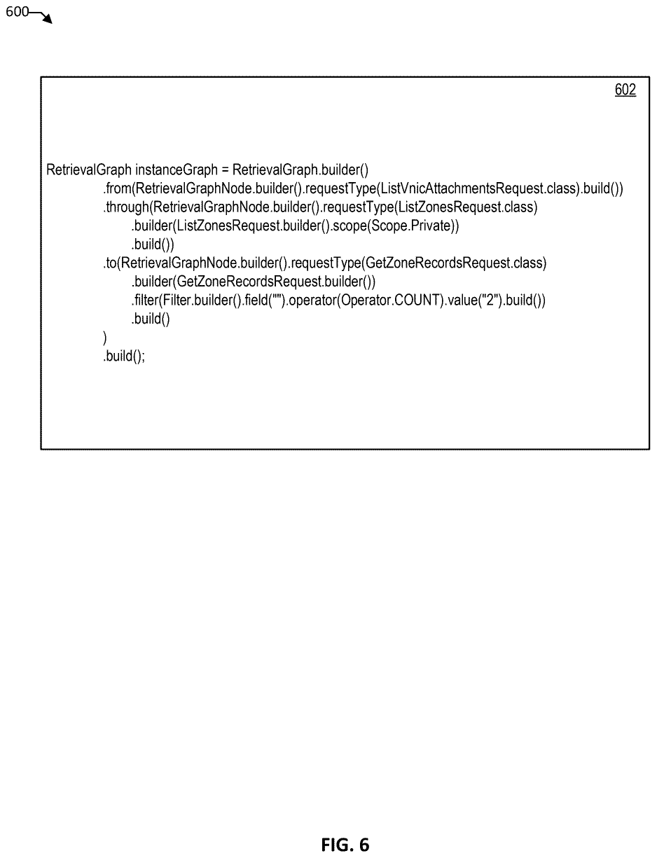

FIGS. 4-6 can be considered a configuration file 402 (e.g., configuration file 112) that is accessed by the computing system based on the input. The configuration file can be stored on the computing system in system memory or other memory. It should be appreciated that the computing system can store multiple configurations files for traversing a data structure and the computing system can select a configuration file based on the parameters of the input. FIG. 5 can be a continuation of FIG. 4. FIG. 6 can be a continuation of FIG. 5. FIG. 4 is an illustration 400 of an example configuration file, according to one or more embodiments. As illustrated, the includes have metadata that relate to accessing a VNIC attachment. For example, it is illustrated that to access the VNIC attachment, the computing system, via an API, is to provide a value for a “$instance.compartmentid.” Referring back to FIG. 3, the value 304 is provided at part on the input 302. As illustrated, the value 304 is “xxxzzz.” However, it should be appreciated that the value 304 may be different in another instance.

FIG. 5 is an illustration 500 of an example configuration file, according to one or more embodiments. As indicated above, FIG. 5 is a continuation of FIG. 4. As illustrated in FIG. 5, the configuration file 402 can have includes for a subnet, a VCN resolver association, and a resolver. To access the subnet, the computing system may need a value 502 from a VNIC attachment. In a conventional system, the computing system may have needed to use manually written code to access the VNIC attachment to obtain the value 502. However, as described herein, the computing system can access the configuration file 402 which can store value 502 to be used to access the subnet. For brevity purposes, the values of the VNIC attachment, the subnet, the virtual cloud network DNS resolver association, the resolver, DNS zones, and the zone record are not illustrated.

The configuration file 402 can also have an include for the VCN DNS resolver association. To access the VCN DNS resolver association, the computing system may need to provide a value 504 from the subnet. In a conventional system, the computing system may have needed to use manually written code to access the subnet to obtain the value 504. As described herein, the computing system can access the configuration file 402 which can store value 504 to be used to access the VCN DNS resolver association.

The configuration file 402 can also have an include for the resolver association. To access the resolver, the computing system may need to provide a value 506 from the VCN DNS resolver association. In a conventional system, the computing system may have needed to use manually written code to access the VCN DNS resolver association to obtain the value 506. As described herein, the computing system can access the configuration file 402, which can store value 506 to be used to access the resolver.

FIG. 6 is an illustration 600 of an example configuration file, according to one or more embodiments. As indicated above, FIG. 6 is a continuation of FIG. 5. The configuration file 402 can have an include for the DNS zones. To access the DNS zones, the computing system may need to provide a value 602 from the DNS zones. In a conventional system, the computing system may have needed to use manually written code to access the resolver to obtain the value 602. As described herein, the computing system can access the configuration file 402 which can store value 506 to be used to access the DNS zones.

The configuration file 402 can have an include for the DNS zone records. To access the DNS zones, the computing system may need to provide a value 604 from the DNS zones a value 606 from the resolver, and a value 608 from a compartment. Therefore, it can be seen that in order to access a resource, the computing system may need to provide multiple values from different preceding resources. In a conventional system, the computing system may have needed to use manually written code to access multiple resources to obtain the value 602 value 604, value 606, and value 608. As described herein, the computing system can access the configuration file 402 which can store these value to be used to access these resources.

As illustrated, the configuration file 402 can store metadata that includes relationship information for accessing the instance, the VNIC attachment, the subnet, the virtual cloud network DNS resolver association, the resolver, DNS zones, and the zone record. This information can enable the computing system to access a target leaf node (e.g., target leaf node 204) without using resource-specific code to traverse each node of a data structure. Furthermore, as a shy-structure graph traversal technique can be used, the computing system does not return information from each node, as that information may not be relevant to a computing device requesting the information from the target leaf node.

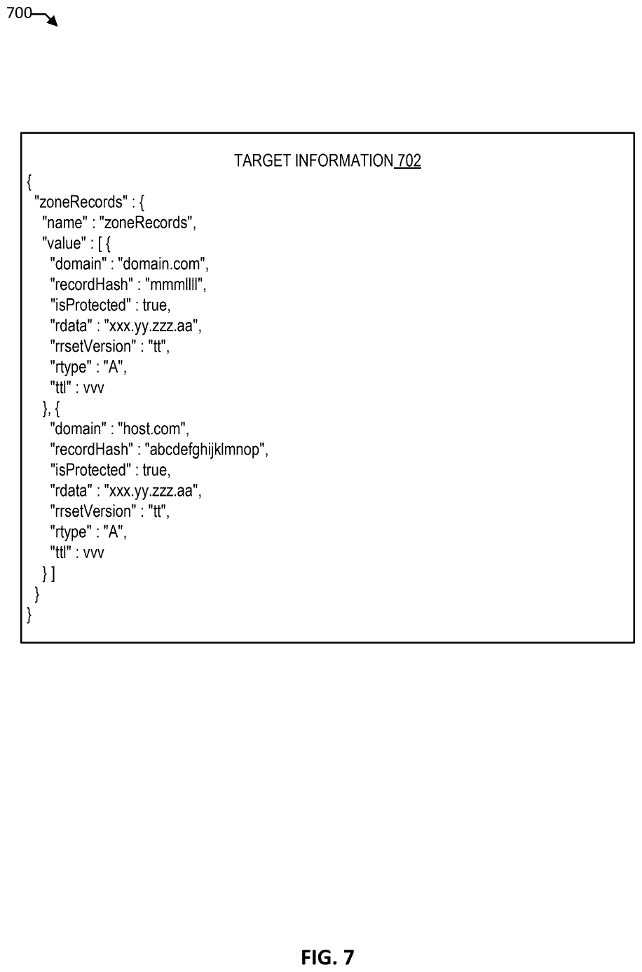

As indicated above, the herein described embodiments can traverse a data structure (e.g., data structure 110) to access information stored in a target leaf node (e.g., target leaf node 204). FIG. 7 is an illustration 700 of example computing code 702 for traversing a data structure using a structure-shy technique, according to one or more embodiments. Upon receiving a request for accessing information from the target leaf node, a computing system (e.g., computing system 102), can execute the illustrated code 702. Continuing with the example from above, a computing system may need to traverse the instance, the VNIC attachment, the subnet, the virtual cloud network DNS resolver association, the resolver, DNS zones, and the zone record to obtain the desired DNS zone records. It is illustrated, that the code 702 does not include references to the instance, the subnet, the virtual cloud network DNS resolver association, the resolver, and DNS zones. As such, the intermediate nodes may not need to be defined in order for the computing system to access a target leaf node (e.g., DNS zone records).

It should be appreciated that FIG. 7 is an example code 702 that follows along with the example described in FIGS. 3-7. If the computing system were tasked with accessing information different than DNS zone records, the values for the code 702 may be different.

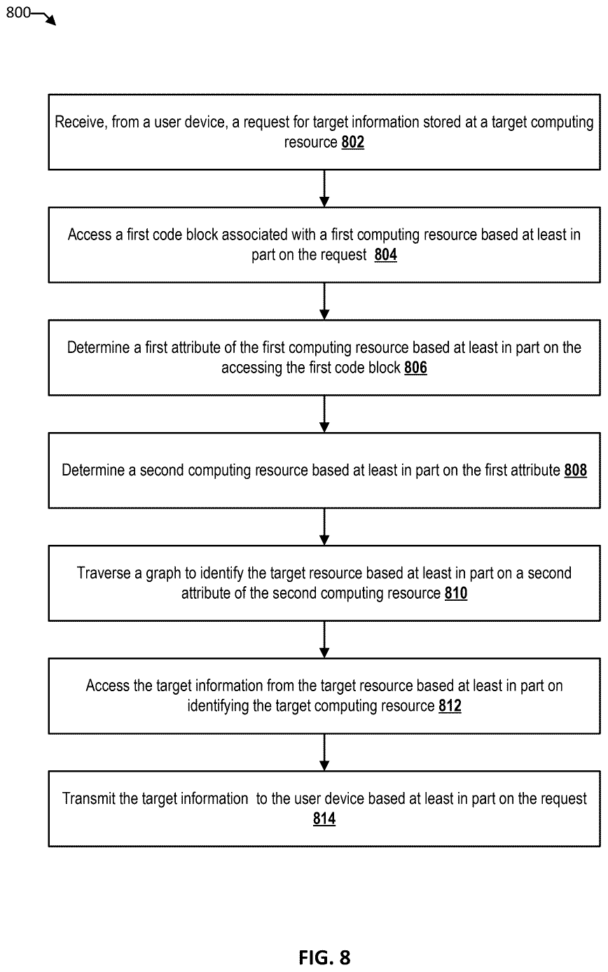

FIG. 8 is an illustration 800 of example target information 802 accessed during a shy-structure graph traversal technique, according to one or more embodiments. A computing system (e.g., computing system 102) can obtain target information 802 (e.g., target information 114) from a resource (e.g., DNS zone records). Continuing with the example from above, it is illustrated that the target information 802 can include information regarding the DNS zone records that are available to an instance. It should be appreciated that the target information does not include information from the instance, the VNIC attachment, the subnet, the virtual cloud network DNS resolver association, the resolver, or the DNS zones. This is a distinction from conventional systems, in which the computing system can use code to access each resource along a path from a root node to a target leaf node. Furthermore, the conventional system may not only traverse each resource, but return information from each resource. As described herein, the relevant information to be used to access a resource (e.g., DNS zone records) is stored as metadata in a configuration file (e.g., configuration file 112). By not providing information from any of the intermediate resources, the herein described computing system can conserve computing resources that may have otherwise used to store and transmit the information. Furthermore, by using the shy-structure graph traversal technique described herein, the does not transmit information to a user device (e.g., user device 104) that may not be needed.

FIG. 9 is an example process 900 for a shy-structure graph traversal according to one or more embodiments. While the operations of process 900 is described as being performed by generic computers, it should be understood that any suitable device may be used to perform one or more operations of this process. Process 900 (described below) is respectively illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

At 902, the process 900 can include a computing system (e.g., computing system 102) receiving, from a user device (e.g., user device 104), a request for target information stored at a target computing resource (e.g., target leaf node). The request can include an identity of a second computing resource (e.g., root node 202) and an identity of the first computing resource. The request can be related to determining whether an application deployment fulfills a set of conditions set by the CSP prior to the application being available to the CSP's customers. The target information (e.g., target information 114) as to whether a condition is fulfilled may be stored in a CSP resource. The request can include a parameter for identifying the first attribute stored in the first computing resource.

At 904, the process 900 can include the computing system accessing a first code block associated with a first computing resource based at least in part on the request.

At 906, the process 900 can include the computing system determining a first attribute of the first computing resource based at least in part on the accessing the first code block. The first attribute can include values for accessing intermediate computing resources to reach the target computing resource.

At 908, the process 900 can include the computing system determining a second computing resource based at least in part on the first attribute. In some embodiments, the computing system can access a first intermediate computing resource. The computing system can store the first attribute as metadata in the configuration file. The computing system can then access the configuration file to identify a second intermediate computing resource, wherein the target computing resource is identified based at least in part on accessing the configuration file. In some embodiments, the configuration file can be generated prior to receiving the request.

In some embodiments, the computing system can identify a target leaf node associated with the first computing resource based at least in part on the request. The computing system can identify a root node associated with the second computing resource based at least in part on the request. The computing system can identify a reverse path comprising the sequence of intermediate computing resources from the target leaf node to the root node, wherein the path is the reverse path in a direction from the root node to the target leaf node.

At 910, the process 900 can include the computing system traversing a graph to identify the target resource based at least in part on a second attribute of the second computing resource.

At 912, the process 900 can include the computing system accessing the target information stored (e.g., target information 114) in the first computing resource based at least in part on identifying the target resource.

At 914 the process 900 can include the computing system transmitting the information stored in the first computing resource to the user device based at least in part on the request.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

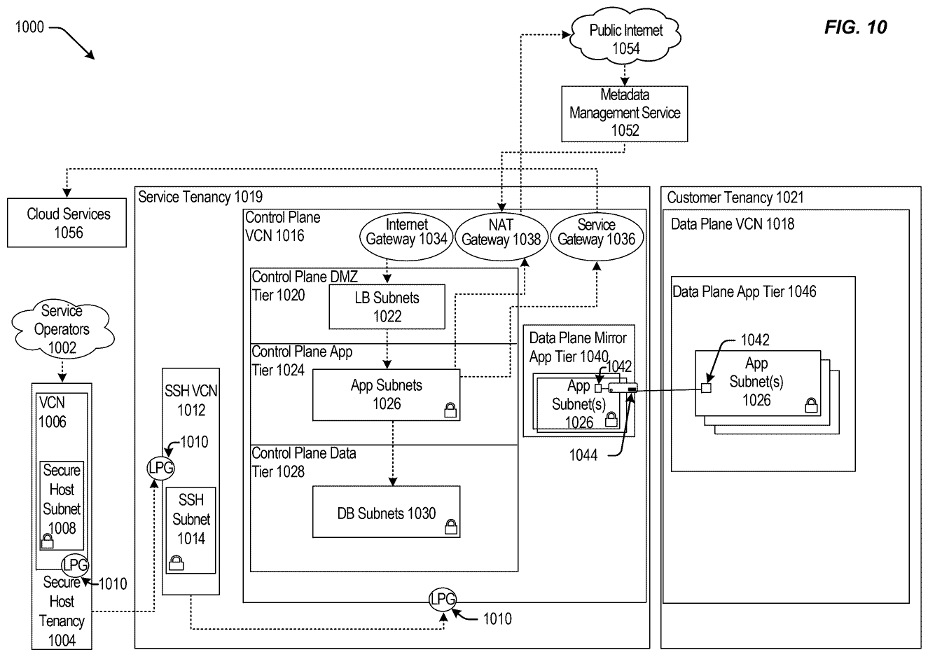

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

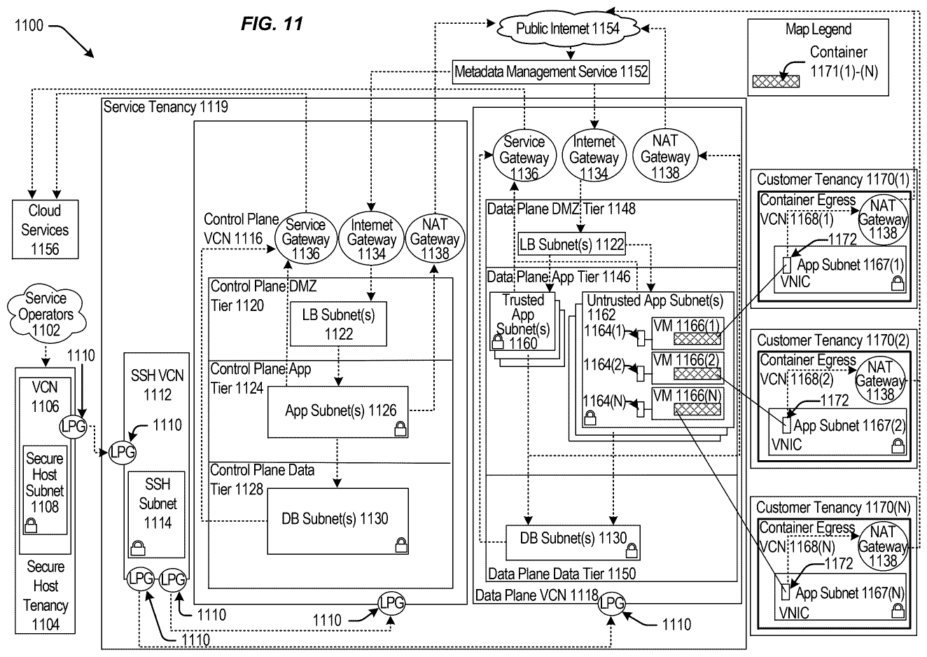

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

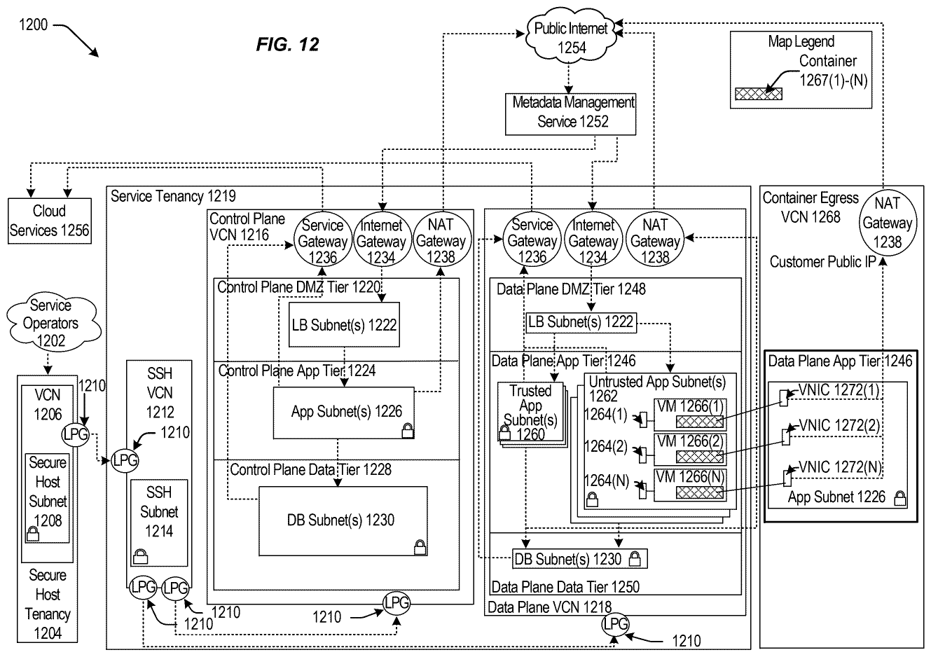

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

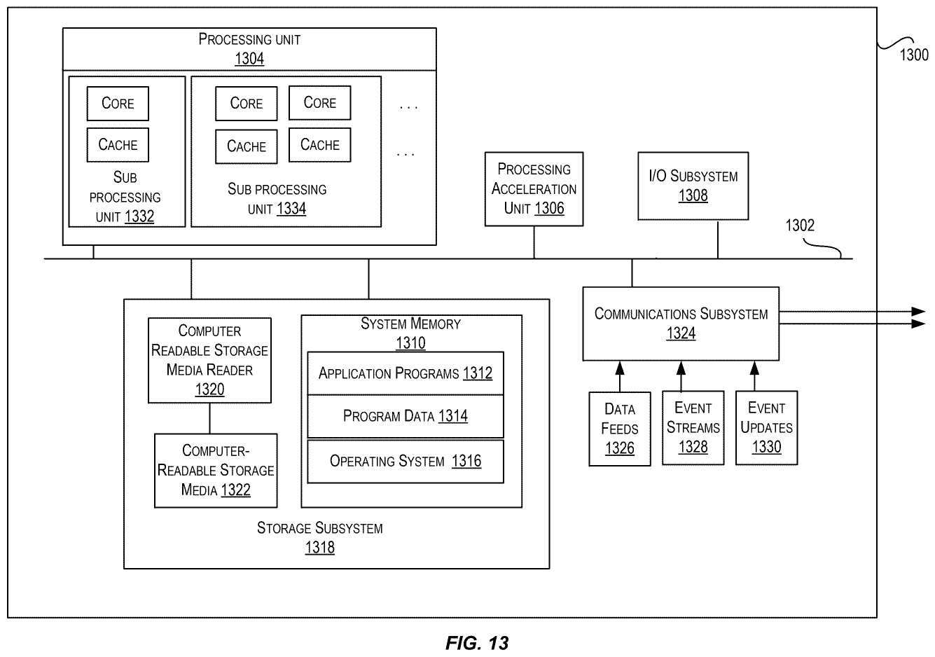

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A method, comprising:
receiving, by a computing system and from a user device, a request for target information stored at a target computing resource;
accessing, by the computing system, a first code block associated with a first computing resource based at least in part on the request;
determining, by the computing system, a first attribute of the first computing resource based at least in part on the accessing the first code block;
determining, by the computing system, a second computing resource based at least in part on the first attribute;
traversing, by the computing system, a resource graph to identify the target computing resource based at least in part on a second attribute of the second computing resource, the resource graph representing the first computing resource, the second computing resource, and the target computing resource;
accessing, by the computing system, the target information from the target computing resource based at least in part on identifying the target computing resource; and
transmitting, by the computing system, the target information to the user device based at least in part on the request.

2. The method of claim 1, wherein the first attribute further comprising values for accessing intermediate computing resources to reach the target computing resource.

3. The method of claim 1, wherein the method further comprises:
accessing a first intermediate computing resource;
storing the first attribute as metadata in a configuration file; and
accessing the configuration file to identify a second intermediate computing resource, wherein the target computing resource is identified based at least in part on accessing the configuration file.

4. The method of claim 3, wherein the configuration file is generated prior to receiving the request.

5. The method of claim 1, wherein the target information is accessed using a graph traversal technique.

6. The method of claim 1, wherein determining the second computing resource comprises:
identifying a target leaf node associated with the first computing resource based at least in part on the request;
identifying a root node associated with the second computing resource based at least in part on the request; and
identifying a reverse path comprising a sequence of intermediate computing resources from the target leaf node to the root node.

7. The method of claim 1, wherein the request comprises a parameter for identifying the first attribute stored in the first computing resource.

8. A computing system, comprising:
one or more processors; and
one or more computer-readable media having stored thereon a sequence of instructions that, when executed, cause the one or more processors to:
receive, from a user device, a request for target information stored at a target computing resource;
access a first code block associated with a first computing resource based at least in part on the request;
determine a first attribute of the first computing resource based at least in part on the accessing the first code block;
determine a second computing resource based at least in part on the first attribute;
traverse a resource graph to identify the target computing resource based at least in part on a second attribute of the second computing resource, the resource graph representing the first computing resource, the second computing resource, and the target computing resource;
access the target information from the target computing resource based at least in part on identifying the target computing resource; and
transmit the target information to the user device based at least in part on the request.

9. The computing system of claim 8, wherein the first attribute further comprising values for accessing intermediate computing resources to reach the target computing resource.

10. The computing system of claim 8, wherein the sequence of instructions that, when executed, further cause the computing system to:
access a first intermediate computing resource;
store the first attribute as metadata in a configuration file; and
access the configuration file to identify a second intermediate computing resource, wherein the target computing resource is identified based at least in part on accessing the configuration file.

11. The computing system of claim 10, wherein the configuration file is generated prior to receiving the request.

12. (canceled)

13. The computing system of claim 8, wherein determining the second computing resource comprises:
identifying a target leaf node associated with the first computing resource based at least in part on the request;
identifying a root node associated with the second computing resource based at least in part on the request; and
identifying a reverse path comprising a sequence of intermediate computing resources from the target leaf node to the root node.

14. The computing system of claim 8, wherein the request comprises a parameter for identifying the first attribute stored in the first computing resource.

15. One or more non-transitory, computer-readable media having stored thereon a sequence of instructions that, when executed, cause a computing system to:
receive, from a user device, a request for target information stored at a target computing resource;
access a first code block associated with a first computing resource based at least in part on the request;
determine a first attribute of the first computing resource based at least in part on the accessing the first code block;
determine a second computing resource based at least in part on the first attribute;
traverse a resource graph to identify the target computing resource based at least in part on a second attribute of the second computing resource, the resource graph representing the first computing resource, the second computing resource, and the target computing resource;
access the target information from the target computing resource based at least in part on identifying the target computing resource; and
transmit the target information to the user device based at least in part on the request.

16. The one or more non-transitory, computer-readable media of claim 15, wherein the first attribute further comprising values for accessing intermediate computing resources to reach the target computing resource.

17. The one or more non-transitory, computer-readable media of claim 15, wherein the sequence of instructions that, when executed, further cause the computing system to:
access a first intermediate computing resource;
store the first attribute as metadata in a configuration file; and
access the configuration file to identify a second intermediate computing resource, wherein the target computing resource is identified based at least in part on accessing the configuration file.

18. The one or more non-transitory, computer-readable media of claim 17, wherein the configuration file is generated prior to receiving the request.

19. The one or more non-transitory, computer-readable media of claim 15, wherein the target information is accessed using a graph traversal technique.

20. The one or more non-transitory, computer-readable media of claim 15, wherein determining the second computing resource comprises:
identifying a target leaf node associated with the first computing resource based at least in part on the request;
identifying a root node associated with the second computing resource based at least in part on the request; and
identifying a reverse path comprising a sequence of intermediate computing resources from the target leaf node to the root node.

21. The method of claim 1, wherein the first computing resource, the second computing resource, and the target computing resource comprise at least one of a compute instance, a virtual network interface card (VNIC) attachment, a subnet, a virtual cloud network (VCN) Domain Name System (DNS) resolver association, a DNS resolver, a DNS zone, a DNS zone record, or a load balancer.
